(19) United States
(12) Patent Application Publication
(10) Pub. No.: US 2026/0173130 A1
(43) Pub. Date: Jun. 18, 2026

(54) Method and system for coexistence of wireless communication protocols

(71) Applicant: Intel Corporation, Santa Clara, CA (US)

(72) Inventors: Mythili HEGDE, Bangalore (IN); Srinivas KROVVIDI, Telengana (IN); Anshu AGARWAL, Bangalore (IN); Chandrashekar DEVEGOWDA, Bangalore (IN); Tarun ARORA, Bengaluru (IN); Vinay Prasad BANGALORE RADHAKRISHNA, Bangalore (IN)

(21) Appl. No.: 18/979,688

(22) Filed: Dec. 13, 2024

(51) Int. Cl. H04W 74/04; H04W 74/08; H04W 84/12

(52) U.S. Cl. CPC H04W 74/04; H04W 74/0866; H04W 84/12

(57) ABSTRACT

A method and system for coexistence of wireless communication protocols sharing a same frequency band. A time schedule is generated for first wireless communication protocol transmissions and second wireless communication protocol transmissions based on a flush timeout parameter for the first wireless communication protocol transmissions or a status of a jitter buffer in a device receiving the first wireless communication protocol transmissions. The time schedule includes first transmission windows for the first wireless communication protocol transmissions, second transmission windows for the second wireless communication protocol transmissions, and third transmission windows for retransmission of the first wireless communication protocol transmissions. The first wireless communication protocol transmissions and the second wireless communication protocol transmissions are controlled based on the time schedule.

### BACKGROUND

Bluetooth and Wi-Fi coexistence is the technique that is used to ensure that both Bluetooth and Wi-Fi devices can operate simultaneously in close proximity without interfering with each other. Bluetooth and Wi-Fi coexistence is needed because both Bluetooth and Wi-Fi operate on the same frequency band (2.4 GHz band), leading to potential interference when they are used simultaneously.

Packet Traffic Arbitration (PTA) is a technique used in Bluetooth and Wi-Fi coexistence systems to manage and prioritize data packet transmissions by the Bluetooth and Wi-Fi devices that share the same frequency band. A PTA controller coordinates the transmission of packets between Bluetooth and Wi-Fi devices to minimize conflicts and maximize efficient use of the shared spectrum. The PTA controller assigns different priority levels to Bluetooth and Wi-Fi packets based on the application. When either Bluetooth or Wi-Fi needs to transmit data, it sends a request to the PTA controller, and the PTA controller grants permission based on the assigned priority level. The PTA controller also manages the timing and sequence of Bluetooth and Wi-Fi packet transmissions.

In conventional Bluetooth and Wi-Fi coexistence algorithms, such as PTA, the timing of transmission and reception is dynamic and profile-based. The conventional Bluetooth and Wi-Fi coexistence algorithms manage shared use of the 2.4 GHz spectrum by dynamically allocating transmission windows between Bluetooth and Wi-Fi, often based on predefined profiles like Bluetooth audio streaming. PTA dynamically allocates time slots for Bluetooth and Wi-Fi based on predefined profiles. Profile-based timesharing uses static or predefined profiles (e.g., Bluetooth audio, file transfer, etc.) to allocate transmission windows. However, the conventional profile-based timesharing lacks flexibility and does not adapt to real-time data needs, causing inefficient timesharing. As a result, Bluetooth is frequently prioritized to avoid interruptions in tasks such as audio playback, which can tolerate very little latency. While this ensures that the Bluetooth link is stable, Wi-Fi throughput is often sacrificed, leading to reduced data rates, slower internet speeds, and poor performance in Wi-Fi-dependent applications like video streaming or online gaming. The timing is unpredictable and adjusts based on the current use case, meaning that when Bluetooth is active, especially with profiles like audio streaming, Wi-Fi's performance deteriorates significantly.

The conventional Bluetooth-Wi-Fi coexistence algorithm over-prioritizes Bluetooth. Bluetooth audio or other high-demand profiles take precedence, and this can cause significant degradation in Wi-Fi performance. Therefore, Wi-Fi throughput can be reduced, leading to slower data transfer, poor internet performance, or even dropped packets in some scenarios. The unpredictable nature of the dynamic, profile-based transmission windowing exacerbates the problem, making it difficult to balance throughput optimally between Bluetooth and Wi-Fi. The current Bluetooth-Wi-Fi coexistence algorithms prioritize for preventing connection drops but fail to optimize the overall throughput for both Bluetooth and Wi-Fi. This trade-off results in an imbalanced performance, with Wi-Fi throughput frequently sacrificed in favor of Bluetooth, without an intelligent mechanism to adapt and balance the needs of both technologies in real time.

### BRIEF DESCRIPTION OF THE FIGURES

Some examples of apparatuses and/or methods will be described in the following by way of example only, and with reference to the accompanying figures, in which

FIG. 1 shows a conventional windowing scheme for Wi-Fi and Bluetooth coexistence;

FIG. 2 shows unplanned Bluetooth retransmissions in the conventional windowing scheme for Wi-Fi and Bluetooth coexistence;

FIG. 3 is a block diagram of an example system for first and second wireless communication protocol coexistence;

FIG. 4 shows an example time schedule with a pre-planned Bluetooth retransmission window;

FIG. 5 is a block diagram of an example system for Bluetooth and Wi-Fi coexistence;

FIG. 6 shows an example time schedule wherein the Bluetooth retransmission window is pre-scheduled to prevent interruption to the Wi-Fi operations;

FIG. 7 is a flow diagram of an example process for coexistence of wireless communication protocols sharing a same frequency band;

FIG. 8 illustrates a user device in which the examples disclosed herein may be implemented; and

FIG. 9 illustrates a base station or infrastructure equipment radio head in which the examples disclosed herein may be implemented.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of A and B”. The same applies for combinations of more than 2 elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

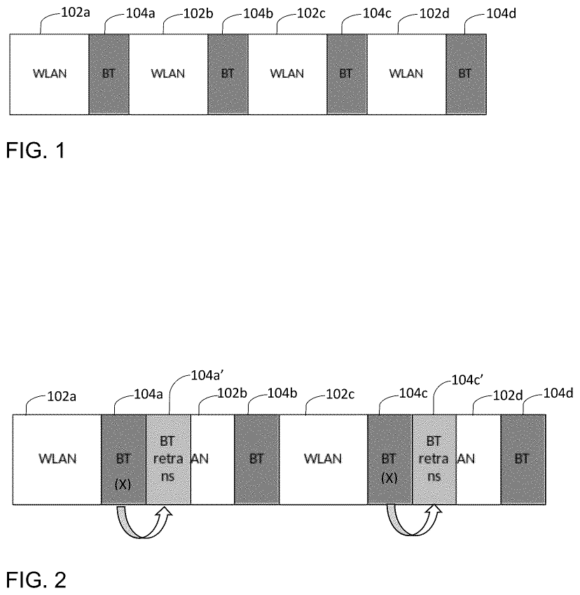

FIG. 1 shows a conventional windowing scheme for Wi-Fi and Bluetooth coexistence. In the conventional scheme, Wi-Fi transmission windows (time slots) 102a-102d and Bluetooth transmission windows 104a-104d may be predefined and scheduled by the coexistence manager in a repeating, deterministic manner. Bluetooth transmission windows 104a-104d are assigned deterministically and periodically. For example, Bluetooth Low Energy (LE) audio, which typically requires low-latency, time-sensitive communication, may be assigned fixed periodic windows. This guarantees that Bluetooth LE audio transmissions occur regularly, without missing their required deadlines. Wi-Fi is given specific transmission windows 102a-102d that do not overlap with Bluetooth's reserved transmission windows 104a-104d. These Wi-Fi transmission windows 102a-102d may also be fixed and repeat in a periodic cycle, allowing for continuous, predictable data transmission without frequent interruptions from Bluetooth. The pre-defined Wi-Fi and Bluetooth transmission windows 102a-102d and 104a-104d alternate. This ensures a balanced time-sharing between Wi-Fi and Bluetooth, avoiding unpredictable or dynamic shifts in resource allocation.

When Bluetooth (e.g., Bluetooth LE audio) needs for retransmissions, the fixed Bluetooth-Wi-Fi windowing can be disturbed sporadically as shown in FIG. 2. FIG. 2 shows unplanned Bluetooth retransmissions in the conventional windowing scheme for Wi-Fi and Bluetooth coexistence. In conventional scheme, when Bluetooth needs a retransmission, the Bluetooth retransmission is extended into the succeeding Wi-Fi transmission window. In the example shown in FIG. 2, the Bluetooth transmissions in time windows 104a and 104c fail and the corresponding retransmissions (indicated as 104 a′ and 104c′) are extended into the first portion of the subsequent Wi-Fi transmission windows 102b and 102d, respectively. This unplanned Bluetooth retransmissions 104a′ and 104c′ can cause interruption to the WLAN transmissions in the Wi-Fi transmission windows 102b and 102d, which can reduce the WLAN throughput.

Examples are disclosed herein for a method and system for coexistence of wireless communication protocols that share a same frequency band. Hereafter, examples will be explained with reference to Bluetooth and Wi-Fi coexistence as an example, but the examples are applicable to any wireless communication protocols that share the same frequency band. The example schemes disclosed herein use a flush timeout parameter-based logic or alternatively a jitter buffer-based logic, to dynamically adjust the transmission time windows for the two wireless communication protocols for better time-sharing between the wireless communication protocols (e.g., Bluetooth and Wi-Fi). By monitoring the flush timeout parameter for the first wireless communication protocol transmissions (e.g., Bluetooth) or the status information (e.g., jitter buffer status information) from a device that receives the wireless communication protocol transmissions (e.g., Bluetooth transmissions) in real-time, the system can make informed decisions about when to prioritize the first or second wireless communication protocol transmissions for optimizing the overall throughput of both wireless communication protocol transmissions. The flush timeout parameter or the status of the jitter buffer can provide insights into the real-time data needs. This allows for adaptive adjustment of transmission windows for the wireless communication protocols, thereby reducing unnecessary sacrifices in the wireless communication protocol throughput.

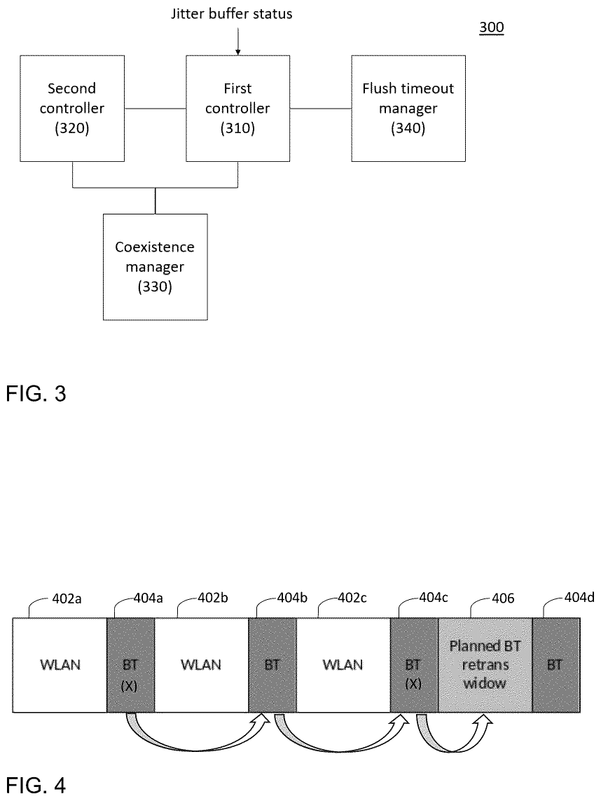

FIG. 3 is a block diagram of an example system for first and second wireless communication protocol coexistence (e.g., Bluetooth and Wi-Fi coexistence). The system 300 includes a first controller 310, a second controller 320, a coexistence manager 330, and a flush timeout manager 340. The first controller 310 is configured to control and manage first wireless communication protocol transmissions. The second controller 320 is configured to control and manage second wireless communication protocol transmissions. The first controller 310 and the second controller 320 manage and control the first wireless communication protocol transmissions and the second wireless communication protocol transmissions, respectively, under the control of the coexistence manager 330. For example, the first controller 310 may send a request for transmission (including retransmissions) to the coexistence manager 330 and transmit/retransmit a first wireless communication protocol packet after obtaining a grant from the coexistence manager 330. The second controller 320 may send a request for transmission (including retransmissions) to the coexistence manager 330 and transmit/retransmit a second wireless communication protocol packet after obtaining a grant from the coexistence manager 330.

The coexistence manager 330 enables cooperative coexistence between the first and second wireless communication protocols. The first and second wireless communication protocol use separate radio frequency (RF) hardware, but they need to coordinate their access to the shared RF medium to avoid corrupted transmission and reception operations. The coexistence manager 330 performs this coordination. Each time first or second wireless communication protocol intends to perform some operation (such as a transmission), the first controller 310 or the second controller 320 sends a request to the coexistence manager 330. The request contains information, such as the operation that each wireless communication protocol intends to perform and/or the priority level of that operation. The coexistence manager 330 then grants or denies access to the RF medium for that request.

The coexistence manager 330 is configured to generate a time schedule for the first wireless communication protocol transmissions and the second wireless communication protocol transmissions. In examples, the time schedule includes first transmission windows for the first wireless communication protocol transmissions, second transmission windows for the second wireless communication protocol transmissions, and third transmission windows for retransmission of the first wireless communication protocol transmissions. The first transmission windows, the second transmission windows, and the third transmission windows may occur periodically or substantially periodically, respectively, in the time schedule. The first and second wireless communication protocol transmissions including retransmissions are controlled in accordance with the time schedule. The third transmission windows are time windows scheduled in advance for potential retransmission needs of the first wireless communication protocol transmissions.

The flush timeout manager 340, which may be part of the first wireless communication protocol firmware, is configured to monitor a flush timeout parameter for queued packets of the first wireless communication protocol transmissions and report the flush timeout parameter to the first controller 310. The flush timeout parameter may then be reported to the coexistence manager 330 by the first controller 310. The status of the jitter buffer in a device that receives the Bluetooth transmissions may also be reported to the coexistence manager 330 via the first controller 310.

A flush timeout parameter is a parameter that determines how long the transmitter should wait for transmission of a packet before discarding it. For example, the flush timeout parameter is the maximum number of transmission events that may be used to transmit and retransmit a given payload. For example, the flush timeout value may be from 1 to 255. Each payload has a flush point, which is a point in time at which the corresponding payload will be discarded by the link layer. In systems that support dynamic coexistence management, the flush timeout parameter may be adjusted based on the current network conditions, application requirements, the quality of service expected by the device, etc.

A jitter buffer is a tool used to manage the variability in packet arrival times. A jitter buffer is a data storage to store incoming data packets temporarily before processing. In communication systems, for example in real-time streaming, packets can arrive at irregular intervals due to network congestion or other factors. A jitter buffer smooths out these variations by temporarily storing packets and releasing them at regular intervals. In the context of Bluetooth and Wi-Fi coexistence, the jitter buffer helps manage the timing of Bluetooth retransmissions.

In example schemes disclosed herein, the coexistence manager 330 is configured to generate the time schedule based on the flush timeout parameter or the jitter buffer status, and subsequently update the time schedule based on the reported flush timeout parameter or jitter buffer status. For example, the coexistence manager 330 may update the time schedule by adding or removing one or more of the third transmission windows in the time schedule based on the flush timeout parameter or the jitter buffer status. For example, the time sharing between Bluetooth and WLAN may be scheduled for each window of every 7.5 msec with an interval of 2.5 msec for Bluetooth and an interval of 5 msec for WLAN. This is merely an example, and the timing may be set differently. For example, the shared time windows may be every 10 msec with an interval of 3.75 msec for Bluetooth and an interval of 6.25 msec for WLAN.

In case of Bluetooth-Wi-Fi coexistence, as the Bluetooth reception device uses a jitter buffer, Bluetooth retransmissions can be scheduled at fixed time intervals (Bluetooth transmission/retransmission windows) rather than allowing them to occur at random times as shown in FIG. 2. This helps in maintaining predictable intervals for WLAN transmissions, reducing the chance of unplanned/unexpected WLAN interruptions or disruptions. In examples, the flush timeout parameter for the Bluetooth transmissions or alternatively the jitter buffer status in the Bluetooth reception device is reported to the coexistence manager, and Bluetooth retransmission windows are scheduled in advance rather than the Bluetooth retransmissions are randomly extended into the subsequent Wi-Fi transmission windows as shown in FIG. 2. This ensures deterministic WLAN windowing without unplanned interruption due to Bluetooth retransmissions.

In some examples, the flush timeout event counter and the event counter for the Bluetooth transmissions may be monitored, and the time schedule may be updated based on the values of the flush timeout event counter and the event counter. The event counter and flush timeout event counter are mechanisms used to manage, monitor, and optimize the coexistence of Bluetooth and Wi-Fi. The event counter in Bluetooth is a counter that keeps track of communication events, such as the number of transmission attempts, retransmissions, or completed packets within a certain period. The values of current event counter, the current payload number, and flush point allows the system to determine the frequency of communication retries, interruptions, or successes, giving insight into the Wi-Fi's impact on Bluetooth operations. The flush timeout event counter tracks the number of times packets are discarded due to the flush timeout. The flush timeout event counter and the event counter may be used as an indicator of the jitter buffer status in the Bluetooth reception device. Therefore, instead of receiving the jitter buffer status from the Bluetooth reception device, the flush timeout event counter and the event counter may be monitored, and the time schedule may be updated based on the values of the flush timeout event counter and the event counter.

FIG. 4 shows an example time schedule with a pre-planned Bluetooth retransmission window. The coexistence manager generates a time schedule for Bluetooth and Wi-Fi transmissions. The time schedule includes Wi-Fi transmission windows 402a-402c, Bluetooth transmission windows 404a-404d, and a Bluetooth retransmission window 406, all scheduled in a repeating, deterministic manner. The Bluetooth retransmission window 406 is pre-scheduled for accommodating the potential needs for Bluetooth retransmissions, which may or may not be used for the Bluetooth retransmissions. FIG. 4 shows only one Bluetooth retransmission window 406, but a plurality of Bluetooth retransmission windows may be scheduled repeatedly or periodically in the time schedule.

In examples, when a Bluetooth retransmission is needed, instead of extending the Bluetooth retransmission into the subsequent Wi-Fi transmission window as shown in FIG. 2, the Bluetooth transmissions and retransmissions are performed in the pre-scheduled transmission/retransmission windows. For example, when a Bluetooth transmission in transmission window 404a fails, the failed Bluetooth transmission in the transmission window 404a is retransmitted in transmission window 404b, and the next Bluetooth transmission is transmitted in transmission window 404c, which fails, and then retransmitted in transmission window 406 and the next Bluetooth transmission is transmitted in the same transmission window 406 since the pre-scheduled Bluetooth retransmission window is sufficient in this example. In this example, as the Bluetooth retransmission window 406 is pre-scheduled, the Bluetooth retransmission needs can be accommodated without interrupting the Wi-Fi transmissions.

In examples, the duration of the planned Bluetooth retransmission window and the repetition period of the planned Bluetooth retransmission windows may be set based on the jitter buffer status and/or the flush timeout parameter. The period of the Bluetooth retransmission windows may be set shorter than the flush timeout parameter. The flush timeout interval defines the number of intervals a packet can be delayed before being successfully transmitted or discarded. For example, with Bluetooth audio isochronous steam interval of 10 msec and flush timeout of 100 msec, a packet transmission can be attempted for maximum 10 intervals before being flushed. With this example, if Bluetooth interval is 2.5 msec in every 10 msec window, a 7.5 msec interval is given to WLAN. With flush timeout of 100 msec in every 100 msec window, Bluetooth getting an extra window of full 10 msec (4 retransmissions) allow static scheduling of Bluetooth and WLAN without extensions to Bluetooth for retransmissions. This fixed retransmission accounts 10% retransmissions with extra 10 msec in 100 msec interval. The coexistence manager may receive the flush timeout parameter and/or the jitter buffer status (jitter buffer occupancy), analyzes the flush timeout values or the jitter buffer status, and adjusts the time schedule (i.e., the Bluetooth transmission and retransmission windows and Wi-Fi transmission windows) accordingly to ensure that there are no unnecessary interruptions to the Wi-Fi transmissions.

The windowing scheme in accordance with the examples disclosed herein schedules Bluetooth retransmissions in a way that minimizes interference to the WLAN (Wi-Fi) transmissions. In examples, the Bluetooth transmissions and retransmissions are spaced out to fit within the planned intervals (the planned Bluetooth and W-Fi transmission windows), allowing WLAN transmissions to occur deterministically and avoiding unnecessary WLAN interruptions.

The jitter buffer allows delaying the Bluetooth retransmissions to a fixed time interval. This delay helps in aligning the Bluetooth retransmissions with the WLAN transmission windows. The flush timeout parameter determines how long the transmitter has to wait before discarding a packet if the packet has not been successfully transmitted. This ensures that retransmissions of the Bluetooth packet occur in a predictable manner and within the planned time windows.

The example schemes disclosed herein provide predictable WLAN performance. By scheduling the Bluetooth retransmissions based on the flush timeout parameter or the jitter buffer status, WLAN transmissions can be planned more precisely, reducing the risk of unplanned interruptions. The example schemes disclosed herein ensures that Bluetooth retransmissions do not interfere with WLAN transmission, leading to better overall performance and efficiency. By using the jitter buffer or flush timeout parameter, the example schemes disclosed herein aim to create a more predictable and manageable environment for both Bluetooth and WLAN transmissions. This coordination helps in minimizing interference and optimizing the performance of both communication systems.

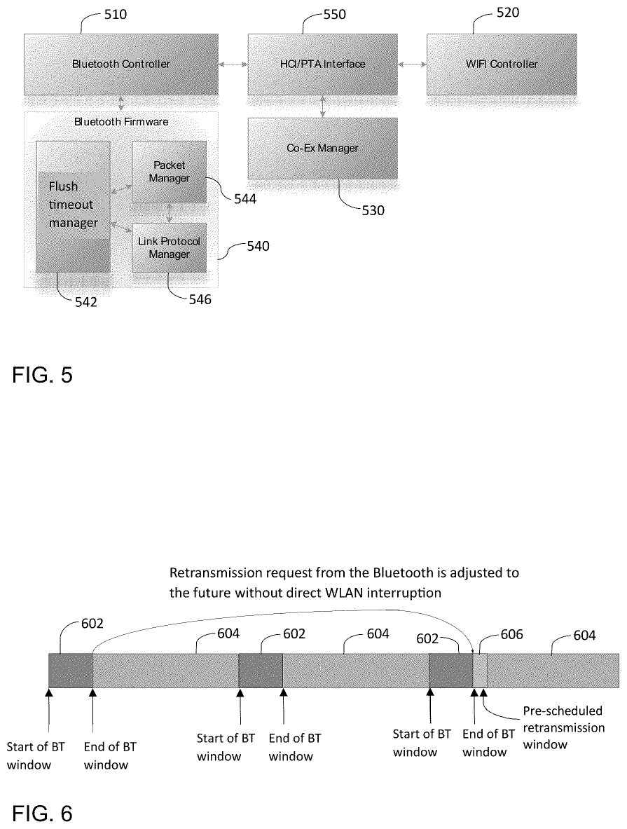

FIG. 5 is a block diagram of an example system for Bluetooth and Wi-Fi coexistence. The system 500 includes a Bluetooth controller 510, a Wi-Fi controller 520, a coexistence manager 530, Bluetooth firmware 540, and HCI/PTA interface 550. The Bluetooth controller 510 is a controller for managing and controlling Bluetooth transmissions and receptions. The Wi-Fi controller 520 manages and controls Wi-Fi transmissions and receptions. The Bluetooth controller 510 and the Wi-Fi controller 520 manage and control the Bluetooth and Wi-Fi transmissions and retransmissions, respectively, under the control of the coexistence manager 530. For example, the Bluetooth controller 510 may send a request for transmission (including retransmissions) to the coexistence manager 530 and transmit a Bluetooth packet after obtaining a grant from the coexistence manager 530. Similarly, the Wi-Fi controller 520 may send a request for transmission (including retransmissions) to the coexistence manager 530 and transmit a Wi-Fi packet after obtaining a grant from the coexistence manager 530. The coexistence manager 530 enables cooperative coexistence between Bluetooth and Wi-Fi. Each time Bluetooth and Wi-Fi protocol intends to perform some operation (such as a transmission), the Bluetooth controller 510 and the Wi-Fi controller 520 sends a request to the coexistence manager 530, and the coexistence manager 530 grants or denies access to the RF medium for the request based on the priority level of the operation.

The Bluetooth firmware 540 may include a flush timeout manager 542, a packet manager 544, and a link protocol manager 546. The flush timeout manager 542 monitors Bluetooth packet timeouts and triggers retransmissions or discarding of the Bluetooth packets. The packet manager 544 coordinates packet transmissions based on buffer and flush timeout states. If a packet has not been transmitted within the time limit (i.e., the flush point), the flush timeout manager 542 discards the packet, and if a packet has not been stored in the buffer over the time limit (i.e., the flush point), the packet may be retransmitted. The link protocol manager 546 manages the Bluetooth connection and ensures that protocol timing is maintained.

The coexistence manager 530 is configured to generate a time schedule for the Bluetooth transmissions and the Wi-Fi transmissions based on the flush timeout parameter for Bluetooth transmissions or the jitter buffer status in the Bluetooth reception device (or alternatively the flush timeout event counter and the event counter in the Bluetooth transmission device). The time schedule includes Wi-Fi transmission windows, Bluetooth transmission windows, and Bluetooth retransmission windows, as shown in FIG. 4. Bluetooth transmission windows, Bluetooth retransmission windows, and Wi-Fi transmission windows may occur periodically or substantially periodically, respectively, in the time schedule and may not overlap each other. Wi-Fi transmissions and Bluetooth transmissions/retransmissions are controlled in accordance with the time schedule. The coexistence manager 530 receives status updates (e.g., flush timeout parameter, the jitter buffer status, or the flush timeout event counter and the event counter) from the Bluetooth controller 510 via the HCI/PTA interface 550 and may update the time schedule based on the status updates. The coexistence manager 530 coordinates with the Wi-Fi controller 520 and the Bluetooth controller 510 for efficient coexistence. The HCI/PTA interface 550 communicates the jitter buffer status and the flush timeout data to the coexistence manager 530, helping in synchronization.

In example schemes disclosed herein, the windowing for (re)transmission is fixed on the Bluetooth side. The Bluetooth retransmission windows are pre-scheduled and Bluetooth transmissions and retransmissions are conducted in the scheduled Bluetooth transmission and retransmission windows. If there is no need for Bluetooth retransmissions (e.g., due to ideal environment), the planned bandwidth for the Bluetooth retransmissions may be given away, for example for some scan activities on Bluetooth or Wi-Fi based on the decision of the coexistence manager. The deterministic retransmission window which may be determined based on the flush timeout parameters and/or the jitter buffer status will allow deterministic WLAN windowing without interruptions to the Wi-Fi operations and throughput of WLAN can become deterministic.

In examples, the duration and periodicity of the Bluetooth retransmission windows are determined based on the flush timeout parameter or the jitter buffer status. This information is shared with the Wi-Fi controller. This allows the deterministic WLAN window and avoids interruption to the WLAN periodically which impacts throughput.

FIG. 6 shows an example time schedule wherein the Bluetooth retransmission window is pre-scheduled to prevent interruption to the Wi-Fi operations. The coexistence manager generates a time schedule including Bluetooth transmission windows 604, Wi-Fi transmission windows 602, and Bluetooth retransmission window 606 for the Wi-Ti and Bluetooth transmissions and retransmissions. The Bluetooth controller monitors the jitter buffer status on the Bluetooth receiving device and/or the flush timeout parameter for queued packets for the Bluetooth transmissions and sends the status updates to the coexistence manager 530, e.g., using status flags, telemetry, and/or PTA messages. The coexistence manager 530 analyzes the jitter buffer status (jitter buffer occupancy) and the flush timeout values and may adjust the time schedule (i.e., the Bluetooth transmission and retransmission windows and the Wi-Fi transmission windows) accordingly to ensure that there are no unnecessary interruptions to the Wi-Fi transmissions. If Bluetooth retransmission is needed, the Bluetooth transmissions and retransmissions are adjusted to the pre-planned Bluetooth transmission and retransmission windows. This results in more deterministic behavior and optimized coexistence between Bluetooth and Wi-Fi, reducing interference and enhancing overall system performance. In examples, by pre-scheduling the Bluetooth retransmission window(s), retransmission requests from the Bluetooth can be adjusted to the future time without direct WLAN interruption.

The example schemes disclosed herein can adaptively and intelligently manage the coexistence of Bluetooth and Wi-Fi by leveraging real-time jitter buffer data and/or the flush timeout parameter. This approach overcomes the limitations of static or profile-based time-sharing methods, offering a more efficient, flexible, and user-friendly way to optimize wireless communication in environments where both Bluetooth and Wi-Fi are in use.

Conventional PTA is profile based and static coexistence schemes for Bluetooth and WLAN time sharing. Conventional schemes over-prioritize Bluetooth. High-demand Bluetooth profiles (e.g., audio) take precedence, degrading Wi-Fi performance. Therefore, Wi-Fi throughput suffers, causing slower speeds and dropped packets. In conventional schemes, transmission timing is unpredictable, and profile-based windowing makes balancing Bluetooth and Wi-Fi throughput challenging.

The example schemes disclosed herein can calculate Bluetooth retransmission needs (e.g., Bluetooth LE audio) using a flush timeout parameter to define retransmission windows and periodicity. The retransmission data may be relayed to the WLAN for deterministic WLAN windows. The example schemes can prevent WLAN interruptions by ensuring predictable transmission scheduling. In example schemes, Wi-Fi/Bluetooth windowing can be adjusted based on the jitter buffer status for optimal coexistence and Bluetooth and Wi-Fi can be balanced without compromising link stability. The example schemes provide a generalized coexistence framework that can optimize multiple wireless technologies.

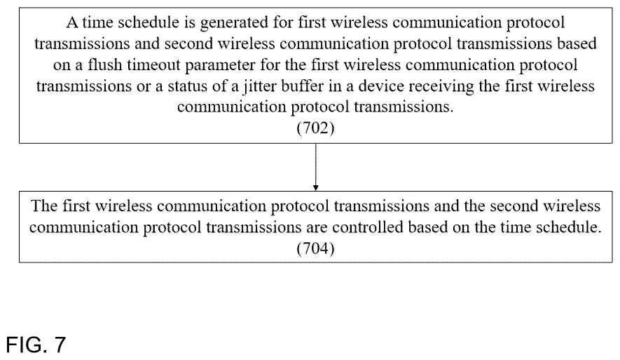

FIG. 7 is a flow diagram of an example process for coexistence of wireless communication protocols sharing a same frequency band. A time schedule is generated for first wireless communication protocol transmissions and second wireless communication protocol transmissions based on a flush timeout parameter for the first wireless communication protocol transmissions or a status of a jitter buffer in a device receiving the first wireless communication protocol transmissions (702). The first wireless communication protocol transmissions and the second wireless communication protocol transmissions share a same frequency band. For example, the first wireless communication protocol transmissions are Bluetooth transmissions, and the second wireless communication protocol transmissions are Wi-Fi transmissions. The Bluetooth transmissions may be Bluetooth Low Energy audio transmissions. The time schedule includes first transmission windows for the first wireless communication protocol transmissions, second transmission windows for the second wireless communication protocol transmissions, and third transmission windows for retransmission of the first wireless communication protocol transmissions. The first wireless communication protocol transmissions and the second wireless communication protocol transmissions are controlled based on the time schedule (704).

The third transmission windows may occur periodically in the time schedule. A duration and a period of the third transmission windows in the time schedule are determined based on the flush timeout parameter or the status of the jitter buffer. The period of the third transmission windows in the time schedule may be set to be shorter than the flush timeout parameter.

In some examples, the flush timeout parameter or the status of the jitter buffer may be monitored in real-time and the time schedule may be updated based on the monitored flush timeout parameter or the status of the jitter buffer. In some examples, the time schedule may be updated based on a flush timeout event counter and an event counter for the first wireless communication protocol transmissions. In some examples, at least one third transmission window may be assigned for other purposes if it is subsequently determined that retransmission of the first wireless communication protocol transmissions is not needed.

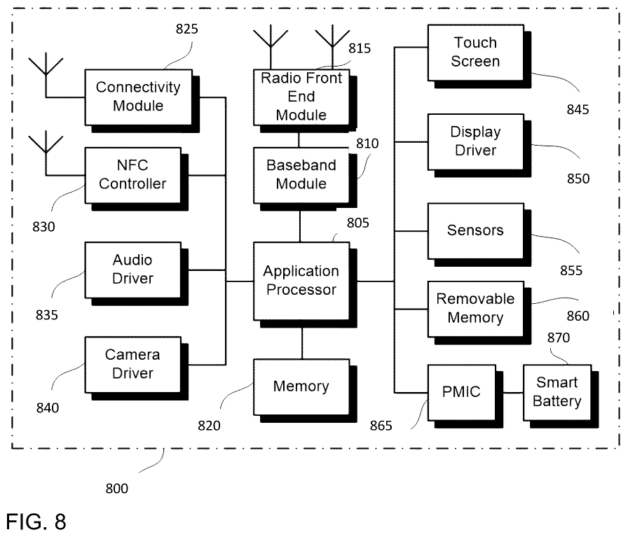

FIG. 8 illustrates a user device 800 in which the examples disclosed herein may be implemented. For example, the examples disclosed herein may be implemented in the radio front-end module 815 (RFEM), in the baseband module 810, etc. The user device 800 may be a mobile device in some aspects and includes an application processor 805, baseband processor 810 (also referred to as a baseband module), radio-front end module 815, memory 820, connectivity module 825, near field communication (NFC) controller 830, audio driver 835, camera driver 840, touch screen 845, display driver 850, sensors 855, removable memory 860, power management integrated circuit (PMIC) 865 and smart battery 870.

In some aspects, application processor 805 may include, for example, one or more CPU cores and one or more of cache memory, low drop-out voltage regulators (LDOs), interrupt controllers, serial interfaces such as serial peripheral interface (SPI), inter-integrated circuit (I2C) or universal programmable serial interface module, real time clock (RTC), timer-counters including interval and watchdog timers, general purpose input-output (IO), memory card controllers such as secure digital/multi-media card (SD/MMC) or similar, universal serial bus (USB) interfaces, mobile industry processor interface (MIPI) interfaces and Joint Test Access Group (JTAG) test access ports.

In some aspects, baseband module 810 may be implemented, for example, as a solder-down substrate including one or more integrated circuits, a single packaged integrated circuit soldered to a main circuit board, and/or a multi-chip module containing two or more integrated circuits.

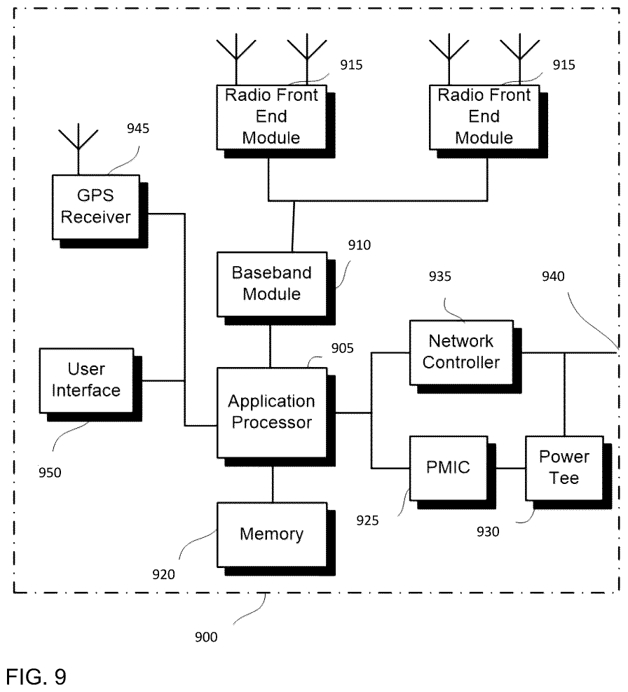

FIG. 9 illustrates a base station or infrastructure equipment radio head 900 in which the examples disclosed herein may be implemented. For example, the examples disclosed herein may be implemented in the radio front-end module 915, in the baseband module 910, etc. The base station radio head 900 may include one or more of application processor 905, baseband modules 910, one or more radio front-end modules 915, memory 920, power management circuitry 925, power tee circuitry 930, network controller 935, network interface connector 940, satellite navigation receiver 945, and user interface 950.

In some aspects, application processor 905 may include one or more CPU cores and one or more of cache memory, low drop-out voltage regulators (LDOs), interrupt controllers, serial interfaces such as SPI, I2C or universal programmable serial interface module, real time clock (RTC), timer-counters including interval and watchdog timers, general purpose IO, memory card controllers such as SD/MMC or similar, USB interfaces, MIPI interfaces and Joint Test Access Group (JTAG) test access ports.

In some aspects, baseband module 910 including processor may be implemented, for example, as a solder-down substrate including one or more integrated circuits, a single packaged integrated circuit soldered to a main circuit board or a multi-chip module containing two or more integrated circuits.

In some aspects, memory 920 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magneto resistive random access memory (MRAM) and/or a three-dimensional crosspoint memory. Memory 920 may be implemented as one or more of solder down packaged integrated circuits, socketed memory modules and plug-in memory cards.

In some aspects, power management circuitry 925 may include one or more of voltage regulators, surge protectors, power alarm detection circuitry and one or more backup power sources such as a battery or capacitor. Power alarm detection circuitry may detect one or more of brown out (under-voltage) and surge (over-voltage) conditions.

In some aspects, power tee circuitry 930 may provide for electrical power drawn from a network cable to provide both power supply and data connectivity to the base station radio head 900 using a single cable.

In some aspects, network controller 935 may provide connectivity to a network using a standard network interface protocol such as Ethernet. Network connectivity may be provided using a physical connection which is one of electrical (commonly referred to as copper interconnect), optical or wireless.

In some aspects, satellite navigation receiver module 945 may include circuitry to receive and decode signals transmitted by one or more navigation satellite constellations such as the global positioning system (GPS), Globalnaya Navigatsionnaya Sputnikovaya Sistema (GLONASS), Galileo and/or BeiDou. The satellite navigation receiver 945 may provide data to application processor 905 which may include one or more of position data or time data. Application processor 905 may use time data to synchronize operations with other radio base stations.

In some aspects, user interface 950 may include one or more of physical or virtual buttons, such as a reset button, one or more indicators such as light emitting diodes (LEDs) and a display screen.

Another example is a computer program having a program code for performing at least one of the methods described herein, when the computer program is executed on a computer, a processor, or a programmable hardware component. Another example is a machine-readable storage including machine readable instructions, when executed, to implement a method or realize an apparatus as described herein. A further example is a machine-readable medium including code, when executed, to cause a machine to perform any of the methods described herein.

The examples as described herein may be summarized as follows:
An example (e.g., example 1) relates to a method for coexistence of wireless communication protocols sharing a same frequency band. The method includes generating a time schedule for first wireless communication protocol transmissions and second wireless communication protocol transmissions based on a flush timeout parameter for the first wireless communication protocol transmissions or a status information from a device (e.g., jitter buffer status) receiving the first wireless communication protocol transmissions, wherein the first wireless communication protocol transmissions and the second wireless communication protocol transmissions share a same frequency band. The method further includes controlling the first wireless communication protocol transmissions and the second wireless communication protocol transmissions based on the time schedule.
Another example, (e.g., example 2) relates to a previously described example (e.g., example 1), wherein the time schedule includes first transmission windows for the first wireless communication protocol transmissions, second transmission windows for the second wireless communication protocol transmissions, and third transmission windows for retransmission of the first wireless communication protocol transmissions.
Another example, (e.g., example 3) relates to a previously described example (e.g., any one of examples 1-2), wherein the third transmission windows occur periodically in the time schedule.
Another example, (e.g., example 4) relates to a previously described example (e.g., any one of examples 1-3), wherein a duration and a period of the third transmission windows in the time schedule are determined based on the flush timeout parameter or the status information.
Another example, (e.g., example 5) relates to a previously described example (e.g., example 4), wherein the period of the third transmission windows in the time schedule is set to be shorter than the flush timeout parameter.
Another example, (e.g., example 6) relates to a previously described example (e.g., any one of examples 1-5), wherein the flush timeout parameter or the status information is monitored in real-time and the time schedule is updated based on the monitored flush timeout parameter or the status information.
Another example, (e.g., example 7) relates to a previously described example (e.g., any one of examples 1-6), wherein the method further includes assigning at least one third transmission window for other purposes if it is subsequently determined that retransmission of the first wireless communication protocol transmissions is not needed.
Another example, (e.g., example 8) relates to a previously described example (e.g., any one of examples 1-7), wherein the first wireless communication protocol transmissions are Bluetooth transmissions, and the second wireless communication protocol transmissions are Wi-Fi transmissions.
Another example, (e.g., example 9) relates to a previously described example (e.g., example 8), wherein the Bluetooth transmissions are Bluetooth Low Energy audio transmissions.
Another example, (e.g., example 10) relates to a previously described example (e.g., any one of examples 1-9), wherein the time schedule is updated based on a flush timeout event counter and an event counter for the first wireless communication protocol transmissions.
Another example, (e.g., example 11) relates to a system for coexistence of wireless communication protocols. The system includes a first controller configured to control first wireless communication protocol transmissions, a second controller configured to control second wireless communication protocol transmissions, wherein the first wireless communication protocol transmissions and the second wireless communication protocol transmissions share a same frequency band, and a coexistence manager configured to generate a time schedule for the first wireless communication protocol transmissions and the second wireless communication protocol transmissions and control the first wireless communication protocol transmissions and the second wireless communication protocol transmissions based on the time schedule, wherein the time schedule is generated based on a flush timeout parameter for the first wireless communication protocol transmissions or a status information from a device receiving the first wireless communication protocol transmissions.
Another example, (e.g., example 12) relates to a previously described example (e.g., example 11), wherein, and the time schedule includes first transmission windows for the first wireless communication protocol transmissions, second transmission windows for the second wireless communication protocol transmissions, and third windows for retransmission of the first wireless communication protocol transmissions.
Another example, (e.g., example 13) relates to a previously described example (e.g., any one of examples 11-12), wherein the third transmission windows occur periodically in the time schedule.
Another example, (e.g., example 14) relates to a previously described example (e.g., any one of examples 11-13), wherein a duration and a period of the third transmission windows in the time schedule are determined based on the flush timeout parameter or the status information.
Another example, (e.g., example 15) relates to a previously described example (e.g., example 14), wherein the period of the third transmission windows in the time schedule is set to be shorter than the flush timeout parameter.
Another example, (e.g., example 16) relates to a previously described example (e.g., any one of examples 11-15), wherein the flush timeout parameter or the status information is monitored in real-time and the time schedule is updated based on the monitored flush timeout parameter or the status information.
Another example, (e.g., example 17) relates to a previously described example (e.g., any one of examples 11-16), wherein the coexistence manager is configured to assign at least one third transmission window for other purposes if it is subsequently determined that retransmission of the first wireless communication protocol transmissions is not needed.
Another example, (e.g., example 18) relates to a previously described example (e.g., any one of examples 11-17), wherein the first wireless communication protocol transmissions are Bluetooth transmissions, and the second wireless communication protocol transmissions are Wi-Fi transmissions.
Another example, (e.g., example 19) relates to a previously described example (e.g., example 18), wherein the Bluetooth transmissions are Bluetooth Low Energy audio transmissions.
Another example, (e.g., example 20) relates to a previously described example (e.g., any one of examples 11-19), wherein the time schedule is updated based on a flush timeout event counter and an event counter for the first wireless communication protocol transmissions.
Another example, (e.g., example 21) relates to a non-transitory machine-readable medium including code, when executed, to cause a machine to generate a time schedule for first wireless communication protocol transmissions and second wireless communication protocol transmissions based on a flush timeout parameter for the first wireless communication protocol transmissions or a status information from a device receiving the first wireless communication protocol transmissions, wherein the first wireless communication protocol transmissions and the second wireless communication protocol transmissions share a same frequency band, and control the first wireless communication protocol transmissions and the second wireless communication protocol transmissions based on the time schedule.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that-although a dependent claim may refer in the claims to a specific combination with one or more other claims-other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. A system for coexistence of wireless communication protocols, comprising:
a first controller configured to control first wireless communication protocol transmissions;
a second controller configured to control second wireless communication protocol transmissions, wherein the first wireless communication protocol transmissions and the second wireless communication protocol transmissions share a same frequency band; and
a coexistence manager configured to generate a time schedule for the first wireless communication protocol transmissions and the second wireless communication protocol transmissions and control the first wireless communication protocol transmissions and the second wireless communication protocol transmissions based on the time schedule,
wherein the time schedule is generated based on a flush timeout parameter for the first wireless communication protocol transmissions or a status information from a device receiving the first wireless communication protocol transmissions.

2. The system of claim 1, wherein the time schedule includes first transmission windows for the first wireless communication protocol transmissions, second transmission windows for the second wireless communication protocol transmissions, and third windows for retransmission of the first wireless communication protocol transmissions.

3. The system of claim 1, wherein the third transmission windows occur periodically in the time schedule.

4. The system of claim 1, wherein a duration and a period of the third transmission windows in the time schedule are determined based on the flush timeout parameter or the status information.

5. The system of claim 4, wherein the period of the third transmission windows in the time schedule is set to be shorter than the flush timeout parameter.

6. The system of claim 1, wherein the flush timeout parameter or the status information is monitored in real-time and the time schedule is updated based on the monitored flush timeout parameter or the status information.

7. The system of claim 1, wherein the first wireless communication protocol transmissions are Bluetooth transmissions, and the second wireless communication protocol transmissions are Wi-Fi transmissions.

8. The system of claim 7, wherein the Bluetooth transmissions are Bluetooth Low Energy audio transmissions.

9. The system of claim 1, wherein the time schedule is updated based on a flush timeout event counter and an event counter for the first wireless communication protocol transmissions.

10. A non-transitory machine-readable medium including code, when executed, to cause a machine to.
generate a time schedule for first wireless communication protocol transmissions and second wireless communication protocol transmissions based on a flush timeout parameter for the first wireless communication protocol transmissions or a status information from a device receiving the first wireless communication protocol transmissions, wherein the first wireless communication protocol transmissions and the second wireless communication protocol transmissions share a same frequency band; and
control the first wireless communication protocol transmissions and the second wireless communication protocol transmissions based on the time schedule.

11. The non-transitory machine-readable medium of claim 10 wherein the time schedule includes first transmission windows for the first wireless communication protocol transmissions, second transmission windows for the second wireless communication protocol transmissions, and third transmission windows for retransmission of the first wireless communication protocol transmissions.

12. A method for coexistence of wireless communication protocols, comprising:
generating a time schedule for first wireless communication protocol transmissions and second wireless communication protocol transmissions based on a flush timeout parameter for the first wireless communication protocol transmissions or a status information from a device receiving the first wireless communication protocol transmissions, wherein the first wireless communication protocol transmissions and the second wireless communication protocol transmissions share a same frequency band; and
controlling the first wireless communication protocol transmissions and the second wireless communication protocol transmissions based on the time schedule.

13. The method of claim 12 wherein the time schedule includes first transmission windows for the first wireless communication protocol transmissions, second transmission windows for the second wireless communication protocol transmissions, and third transmission windows for retransmission of the first wireless communication protocol transmissions.

14. The method of claim 12, wherein the third transmission windows occur periodically in the time schedule.

15. The method of claim 14, wherein a duration and a period of the third transmission windows in the time schedule are determined based on the flush timeout parameter or the status information.

16. The method of claim 15, wherein the period of the third transmission windows in the time schedule is set to be shorter than the flush timeout parameter.

17. The method of claim 12, wherein the flush timeout parameter or the status information is monitored in real-time and the time schedule is updated based on the monitored flush timeout parameter or the status information.

18. The method of claim 12, wherein the first wireless communication protocol transmissions are Bluetooth transmissions, and the second wireless communication protocol transmissions are Wi-Fi transmissions.

19. The method of claim 18, wherein the Bluetooth transmissions are Bluetooth Low Energy audio transmissions.

20. The method of claim 12, wherein the time schedule is updated based on a flush timeout event counter and an event counter for the first wireless communication protocol transmissions.
